(19) United States
(12) Patent Application Publication
(10) Pub. No.: US 2010/0203367 A1
(43) Pub. Date: Aug. 12, 2010

(54) END COVER ASSEMBLY FOR BATTERY AND BATTERY CONTAINING THE SAME

(75) Inventors: Guoyong Che, Shanghai (CN); Huajun Sun, Shanghai (CN)

Correspondence Address: BRINKS HOFER GILSON & LIONE, P.O. BOX 10395, CHICAGO, IL, 60610, US

(73) Assignee: Shanghai BYD Company Limited, Shanghai (CN)

(21) Appl. No.: 12/702,941

(22) Filed: Feb. 9, 2010

(30) Foreign Application Priority Data
Feb. 12, 2009 (CN) 200920067725.7

(51) Int. Cl. H01M 2/00; H01M 2/12

(52) U.S. Cl. 429/61; 429/56

(57) ABSTRACT

An end cover assembly for a battery with a core comprises a contact terminal, a conductive element, and a thermistor. The conductive element is in electrical communication with the core of the battery. The thermistor is disposed between the terminal and the conductive element. The thermistor electrically connects the terminal and the conductive element when the temperature of the battery is below a predetermined temperature. The thermistor electrically disconnects the terminal and the conductive element when the temperature of the battery is above the predetermined temperature.

The present application claims priority to Chinese Patent Application No. 200920067725.7, filed Feb. 12, 2009, the entirety of which is hereby incorporated by reference.

### TECHNICAL FIELD

The present invention relates to a battery, in particular to an end cover assembly for a battery and a battery containing the same.

### BACKGROUND

Lithium secondary batteries are becoming the main power supply for portable electronic devices because of their advantages, such as low weights, small volumes, less-pollution, low internal pressures and low costs. When lithium batteries are used, especially during high current discharging or short circuit, there may be safety risks. For example, they may swell, burn, or even explode. To solve the safety problems, one may improve the chemistry performance of the positive or negative active materials. The other approach is to improve the design of the battery structure.

Typically, the positive active material used in lithium secondary batteries is lithium transition metal oxides. Carbon materials are used as negative materials. The electrolyte solution contains organic solvents, such as EC(ethylene carbonate), PC(propylene carbonate), DEC(diethyl carbonate) , EMC(methyl ethyl carbonate), DMC(dimethyl carbonate); and electrolyte salts, such as LiPF6, LiBF4, LiAsF6, LiCIO4, lithium halogenate, lithium chlorine aluminate, lithium perfluoroalkyl phosphate oxyfluoride salt, lithium perfluoroalkyl sulfonate salt, and so on. When the battery is working under overcharge conditions, the internal temperature of the battery will rise. Without control and protective devices, the battery may explode and burn.

The end cover assembly for cylindrical lithium secondary batteries is a key in the safe structure design. FIG. 1 shows a typical structure of an end cover assembly for cylindrical lithium secondary batteries. The end cover assembly comprises an upper cap 1, a sealing ring 2, an annular conductive plate 3, an anti-explosion plate 4, a current interrupt device (CID) 5. The anti-explosion plate 4 is bent downwards and is welded with CID 5. The annular conductive plate 3 is disposed between and in contact with the upper cap 1 and the anti-explosion plate 4. The upper cap 1, the annular conductive plate 3, the anti-explosion plate 4 are secured by the sealing ring 2 to avoid to be in contact with the battery shell. However, for the battery having this end cover assembly, when the internal pressure of the battery has not yet reached the breaking pressure of the anti-explosion plate, the anti-explosion plate may become convex because of the pressure. The edge may stretch and cause distortion. In this case, the sealing ring which is in contact with the anti-explosion plate may move and cause sealing failure and leakage of battery liquid. The electrolyte may cause corrosion to the external circuitry and the metal shell. It may cause explosion and accidents. In addition, while the internal temperature increases, the internal pressure rises to an extent that it can not break the CID plate, it is not easy to realize the high temperature protection function.

### BRIEF SUMMARY

In one aspect, an end cover assembly for a battery with a core comprises a contact terminal, a conductive element, and a thermistor. The conductive element is in electrical communication with the core of the battery. The thermistor is disposed between the terminal and the conductive element. The thermistor electrically connects the terminal and the conductive element when the temperature of the battery is below a predetermined temperature. The thermistor electrically disconnects the terminal and the conductive element when the temperature of the battery is above the predetermined temperature.

In another aspect, an end cover assembly for a battery with a core comprises a contact terminal, a conductive element, and a thermistor. The terminal comprises a protruding section and a rim. The protruding section and the rim form a hat-shaped structure. The conductive element is in electrical communication with the core. The conductive element comprises a first section, a second section, and a third section. The first section is generally flat and generally parallel to the rim of the terminal. The second section is integral with the first section, extending from the perimeter of the first section in a direction perpendicular to the first section and toward the protruding section of the terminal. The third section is integral with the second section, extending from the second section in a direction perpendicular to the second section and inward toward the protruding section of the terminal. The thermistor is disposed between the rim of the terminal and the first section of the conductive element. The thermistor electrically connects the terminal and the conductive element when the temperature of the battery is below a predetermined temperature. The thermistor electrically disconnects the terminal and the conductive element when the temperature of the battery is above the predetermined temperature.

In yet another aspect, a battery comprises a shell having an opening, a core disposed in the shell, and an end cover assembly. The end cover assembly comprises a contact terminal, a conductive element, and a thermistor. The conductive element is in electrical communication with the core of the battery. The thermistor is disposed between the terminal and the conductive element. The thermistor electrically connects the terminal and the conductive element when the temperature of the battery is below a predetermined temperature. The thermistor electrically disconnects the terminal and the conductive element when the temperature of the battery is above the predetermined temperature.

### BRIEF DESCRIPTION OF THE DRAWINGS

FIG. 1 is a cross sectional view of an end cover assembly for a cylindrical lithium secondary battery in the prior art.

FIG. 2 is a cross sectional view of an end cover assembly according to one embodiment of the present disclosure.

FIG. 3 is a cross sectional view of a battery having an end cover assembly according to one embodiment of the present disclosure.

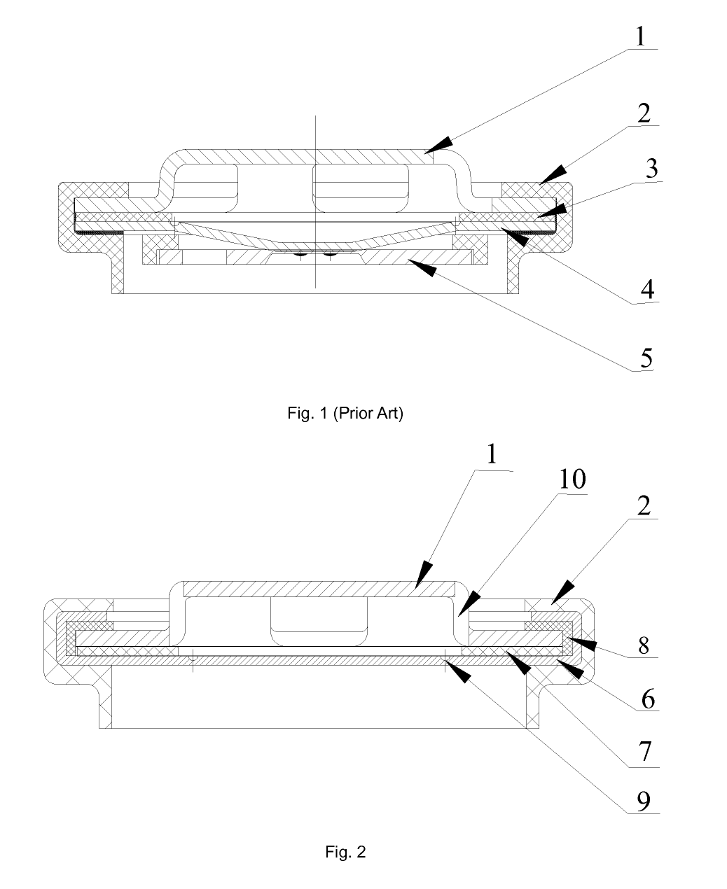

### DETAILED DESCRIPTION OF THE PREFERRED EMBODIMENTS

The preferred embodiments of present invention are described as follows in conjunction with the drawings.

Referring to FIG. 2, according to one embodiment, an end cover assembly for a battery comprises a contact terminal 1, a thermistor 7, and a conductive element 6. The terminal 1 has a hat-shaped structure, including a protruding section and a rim. The terminal 1 can be any suitable conductive material, such as metal. Preferably, the terminal 1 is made of steel. Preferably, the terminal 1 has a pressure release device. In one embodiment, the pressure release device is an opening 10. The air in the battery can be released from the opening 10 to reduce the internal pressure of the battery.

The conductive element 6 is in electrical communication with the battery core. The conductive element 6 includes three sections: a first section, a second section and a third section. The first section is generally flat and generally parallel to the rim of the terminal. The second section is integral with the first section, extending from the perimeter of the first section in a direction perpendicular to the first section and toward the protruding section of the terminal. The third section is integral with the second section, extending from the second section in a direction perpendicular to the second section and inward toward the protruding section of the terminal. The term “parallel” means parallel or substantially parallel. The term “perpendicular” means perpendicular or substantially perpendicular.

The conductive element 6 can be any suitable conductive material, such as metal. Preferably, the conductive element 6 is formed of aluminum. Preferably, the conductive element 6 has a weak structure. When the pressure of the battery is above a predetermined value, the weak structure breaks, therefore separating the electrical connection between the core and the assembly. Preferably, the weak structure is a groove on the first section of the conductive element 6. While the internal pressure of the battery exceeds a predetermined pressure, the conductive element 6 breaks and releases the internal pressure, therefore preventing the explosion of the battery. The phrase “predetermined pressure” means a selected pressure, under which the battery is in a normal operating mode.

The thermistor 7 is disposed between the rim of the terminal 1 and the first section of the conductive element 6. Therefore it prevents the contact between the rim of the terminal 1 and the first section of the conductive element 6. The thermistor 7 electrically connects the conductive element 6 and the terminal 1 when the temperature of the battery is below a predetermined temperature. When the temperature of the battery is above the predetermined temperature, the thermistor electrically disconnects the conductive element 6 and the terminal 1. The phrase “predetermined temperature” means a selected temperature, under which the battery is in a normal operating mode. The phrase “predetermined temperature” also refers to a selected temperature range, i.e. with an upper and a lower limit.

The thermistor 7 can be any suitable material with a positive temperature coefficient. The resistance of the thermistor 7 increases with increasing temperature. Preferably, the thermistor 7 comprises a polymer. When the temperature of the battery exceeds the critical temperature of the thermistor 7, the resistance of the thermistor 7 increases to a certain level to cut off the battery current. The thermistor 7 can be in any suitable shape. For an end cover assembly for a cylindrical battery, preferably, the thermistor 7 has an annular shape. The phrase “cylindrical” means cylindrical or substantially cylindrical.

Preferably, the end cover assembly further comprises an insulating element 8. The insulating element 8 is disposed between the rim of the terminal 1 and the conductive element 6. Preferably, the insulating element comprises two portions. The first portion is disposed between the thermistor 7 and the second section of the conductive element 6. The first portion is also disposed between the rim of the terminal 1 and the second section of the conductive element 6. The second portion is disposed between the rim of the terminal and the third section of the conductive element 6. Thus, the rim of the terminal 1 and the third section of the conductive element 6 are electrically disconnected. The terminal 1 and the conductive element 6 only electrically connect to each other through the thermistor 7.

The insulating element 8 can be any suitable electrical insulating material, such as polypropylene and so on. Preferably, the insulating element 8 is polypropylene.

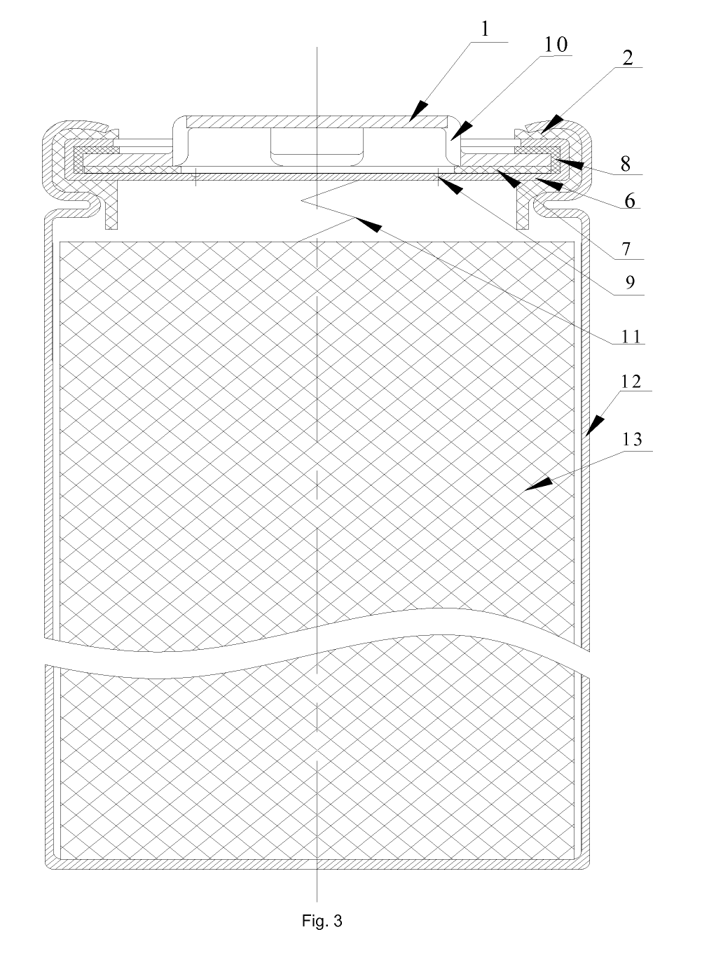

Referring to FIGS. 2 and 3, the end cover assembly further comprises a sealing element 2. The sealing element 2 surrounds at least a part of the first section, the second section and the third section of the conductive element 6, therefore protecting the assembly from contacting with the battery shell.

The sealing element 2 can be any suitable electrical insulating material, such as polypropylene and so on. The sealing element 2 is adapted to mate with the conductive element 6 to prevent the electrolyte of the battery from leaking.

As shown in FIG. 3, a battery has an end cover assembly according to one embodiment of the present disclosure. The battery comprises a battery shell 12, an end cover assembly, and a core 13. The shell 12 has an opening and the end cover assembly closes the opening. The core 13 is placed in the battery shell 12. The core 13 can be any suitable core, such as a coiled core. The core has a positive tab 11 and a negative tab (not shown in the drawing).

Referring to FIG. 3, the end cover assembly comprises a contact terminal 1, a thermistor 7, a conductive element 6, a sealing element 2, and an insulating element 8. The sealing element 2 is disposed between the conductive element 6 and the battery shell 12. It prevents the electrical contact between the end cover assembly and the battery shell 12. Meanwhile, the tight mating between the conductive element 6 and the sealing element 2 may prevent the leakage of battery electrolytes. The positive tab 11 of the core is welded with the conductive element 6. The negative tab is electrically connected to the shell. The end cover assembly closes the opening of the shell and the shell is sealed.

Many modifications and other embodiments of the present disclosure will come to mind to one skilled in the art to which the present disclosure pertains having the benefit of the teachings presented in the foregoing description. It will be apparent to those skilled in the art that variations and modifications of the present disclosure can be made without departing from the scope or spirit of the present disclosure. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. An end cover assembly for a battery with a core comprising:
a contact terminal;
a conductive element in electrical communication with the core of the battery; and
a thermistor disposed between the terminal and the conductive element;
wherein the thermistor electrically connects the terminal and the conductive element when the temperature of the battery is below a predetermined temperature; and wherein the thermistor electrically disconnects the terminal and the conductive element when the temperature of the battery is above the predetermined temperature.

2. The assembly of claim 1, wherein the thermistor comprises a polymer.

3. The assembly of claim 1, further comprising a pressure release device.

4. The assembly of claim 3, wherein the pressure release device is an opening on the terminal.

5. The assembly of claim 1, wherein the terminal is formed of steel.

6. The assembly of claim 1, wherein the conductive element comprises a weak structure, and wherein the weak structure breaks thereby releasing the pressure of the battery when the pressure of the battery is above a predetermined value.

7. The assembly of claim 1, wherein the conductive element is formed of aluminum.

8. An end cover assembly for a battery with a core comprising:
a contact terminal comprising a protruding section and a rim; wherein the protruding section and the rim form a hat-shaped structure;
a conductive element in electrical communication with the core, comprising:
a first section being generally flat and generally parallel to the rim of the terminal;
a second section integral with the first section, extending from the perimeter of the first section in a direction perpendicular to the first section and toward the protruding section of the terminal; and
a third section integral with the second section, extending from the second section in a direction perpendicular to the second section and inward toward the protruding section of the terminal; and
a thermistor disposed between the rim of the terminal and the first section of the conductive element;
wherein the thermistor electrically connects the terminal and the conductive element when the temperature of the battery is below a predetermined temperature; and wherein the thermistor electrically disconnects the terminal and the conductive element when the temperature of the battery is above the predetermined temperature.

9. The assembly of claim 8, further comprising an insulating element disposed between the rim of the terminal and the conductive element.

10. The assembly of claim 9, wherein the insulating element comprises a portion disposed between the rim of the terminal and the third section of the conductive element.

11. The assembly of claim 9, wherein the insulating element is formed of polypropylene.

12. The assembly of claim 8, further comprising a sealing element surrounding at least a part of the first section, the second section and the third section of the conductive element.

13. The assembly of claim 8, wherein the assembly is adapted for a cylindrical battery.

14. The assembly of claim 8, wherein the conductive element comprises a groove on the first section; and wherein the groove breaks thereby releasing the pressure of the battery when the pressure of the battery is above a predetermined value.

15. A battery comprising:
a shell having an opening;
a core disposed in the shell; and
an end cover assembly comprising:
a contact terminal;
a conductive element in electrical communication with the core; and
a thermistor disposed between the terminal and the conductive element; wherein the thermistor electrically connects the terminal and the conductive element when the temperature of the battery is below a predetermined temperature; wherein the thermistor electrically disconnects the terminal and the conductive element when the temperature of the battery is above the predetermined temperature;
wherein the end cover assembly closes the opening of the shell.

16. The battery of claim 15, wherein the core comprises a positive tab and a negative tab.

17. The battery of claim 16, wherein the positive tab is electrically connected to the conductive element.

18. The battery of claim 16, wherein the negative tab is electrically connected to the shell.

19. The battery of claim 15, wherein the end cover assembly further comprises a sealing element disposed between the end cover assembly and the shell.

20. The battery of claim 15, having a cylindrical shape.
